(19) United States
(12) Patent Application Publication
(10) Pub. No.: US 2017/0180952 A1
(43) Pub. Date: Jun. 22, 2017

(54) METHOD AND APPARATUS FOR SUPPORTING BROADCAST MOBILE CONVERGENCE IN WIRELESS COMMUNICATION SYSTEM

(71) Applicant: LG ELECTRONICS INC., Seoul (KR)

(72) Inventors: Sangwon KIM, Seoul (KR); Youngdae LEE, Seoul (KR)

(73) Assignee: LG ELECTRONICS INC., Seoul (KR)

(21) Appl. No.: 15/325,374

(22) PCT Filed: Aug. 4, 2015
(86) PCT No.: PCT/KR2015/008120

§ 371 Date: Jan. 10, 2017

Related U.S. Application Data
(60) Provisional application No. 62/033,083, filed on Aug. 4, 2014.

(51) Int. Cl. H04W 4/06; H04W 72/00; H04W 72/04; H04W 16/14; H04W 72/12

(52) U.S. Cl. CPC H04W 4/06; H04W 16/14; H04W 72/1289; H04W 72/0453; H04W 72/121; H04W 72/005

(57) ABSTRACT

A method and apparatus for receiving information for TV broadcast in a wireless communication system is provided. A user equipment (UE) receives first control information on a first frequency, and receives second control information on a second frequency. The first frequency may be a 3rd generation partnership project (3GPP) long-term evolution (LTE) frequency, and the second frequency may be a TV broadcast frequency.

### BACKGROUND OF THE INVENTION

Field of the Invention

The present invention relates to wireless communications, and more particularly, to a method and apparatus for supporting broadcast mobile convergence in a wireless communication system.

Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

The 3GPP LTE can provide a multimedia broadcast multicast service (MBMS). The MBMS is a service which simultaneously transmits data packets to multiple users. If a specific level of users exists in the same cell, the respective users can be allowed to share necessary resources so that the plurality of users can receive the same multimedia data, thereby increasing resource efficiency. In addition, a multimedia service can be used with a low cost from the perspective of users.

TV broadcast system is vulnerable to mobility. Accordingly, it has been discussed that LTE MBMS can be used for TV broadcast on TV broadcast frequency for mobility enhancement. When LTE MBMS is used for TV broadcast, a method for receiving MBMS related system information may be required.

### SUMMARY OF THE INVENTION

The present invention provides a method and apparatus for supporting broadcast mobile convergence in a wireless communication system. The present invention provides a method and apparatus for receiving multimedia broadcast multicast service (MBMS) related system information when 3rd generation partnership project (3GPP) long-term evolution (LTE) MBMS is used for TV broadcast.

In an aspect, a method for receiving, by a user equipment (UE), information for TV broadcast in a wireless communication system is provided. The method includes receiving first control information on a first frequency, and receiving second control information on a second frequency.

The first frequency may be a 3rd generation partnership project (3GPP) long-term evolution (LTE) frequency. The second frequency may be a TV broadcast frequency.

The first control information may include scheduling information for the second control information. The first control information may include a system information block type 1 (SIB1). The first control information may include information on TV broadcast system. The information on TV broadcast system may include at least one of a system type of the TV broadcast system, a system version of the TV broadcast system, downlink bandwidth for the TV broadcast system, or the second frequency and time frames where a multicast-broadcast single-frequency network (MBSFN) area is configured.

The first control information may include scheduling information for user data on the second frequency. The first control information may include a SIB15. The first control information may include information on multimedia broadcast multicast service (MBMS) service area configured on the second frequency. The information on MBMS service area configured on the second frequency may include the second frequency and time frames where the MBMS service area is configured.

The second control information may include scheduling information for user data on the second frequency. The second control information may include a SIB13 or SIB15. The second control information may be received during a time period which is reserved for LTE MBMS.

In another aspect, a user equipment (UE) includes a memory, a transceiver, and a processor coupled to the memory and the transceiver, and configured to control the transceiver to receive first control information on a first frequency, and control the transceiver to receive second control information on a second frequency.

TV broadcast can be supported efficiently by LTE MBMS.

### BRIEF DESCRIPTION OF THE DRAWINGS

FIG. 1 shows LTE system architecture.

FIG. 2 shows a block diagram of architecture of a typical E-UTRAN and a typical EPC.

FIG. 3 shows a block diagram of a user plane protocol stack of an LTE system.

FIG. 4 shows a block diagram of a control plane protocol stack of an LTE system.

FIG. 5 shows an example of a physical channel structure.

FIG. 6 shows MBMS definitions.

FIG. 7 shows change of MCCH information.

FIG. 8 shows an MCCH information acquisition procedure.

FIG. 9 shows an MBMS interest indication procedure.

FIG. 10 shows an MBMS counting procedure.

FIG. 11 shows an example of TV broadcast by LTE MBMS according to an embodiment of the present invention.

FIG. 12 shows an example of a method for receiving information for TV broadcast according to an embodiment of the present invention.

FIG. 13 shows an example of a TV broadcast interest indication procedure according to an embodiment of the present invention.

FIG. 14 shows an example of a TV broadcast counting procedure according to an embodiment of the present invention.

FIG. 15 shows a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

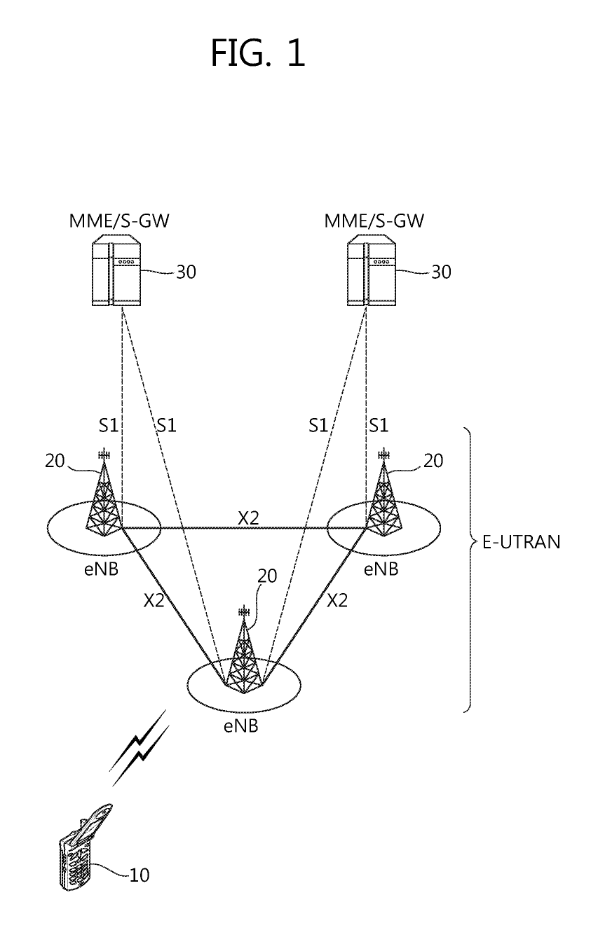

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a system architecture evolution (SAE) gateway (S-GW). The MME/S-GW 30 may be positioned at the end of the network and connected to an external network. For clarity, MME/S-GW 30 will be referred to herein simply as a “gateway,” but it is understood that this entity includes both the MME and S-GW.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an S1 interface.

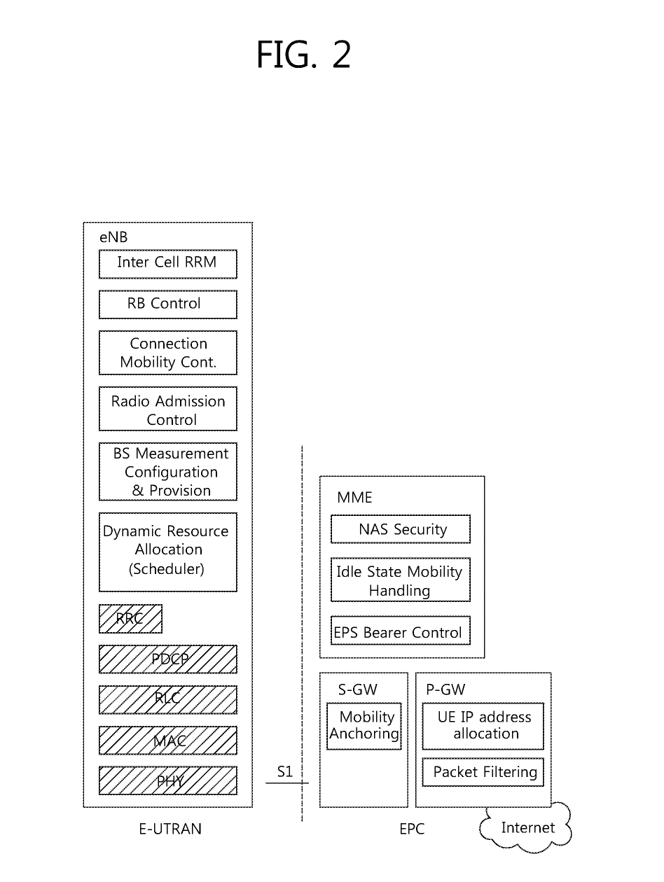

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

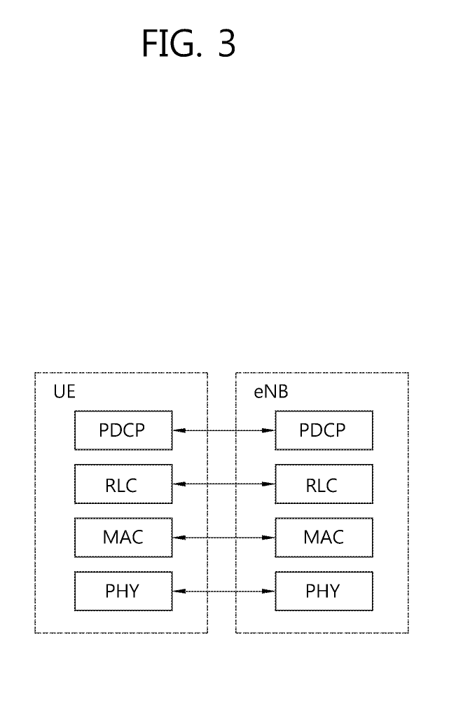

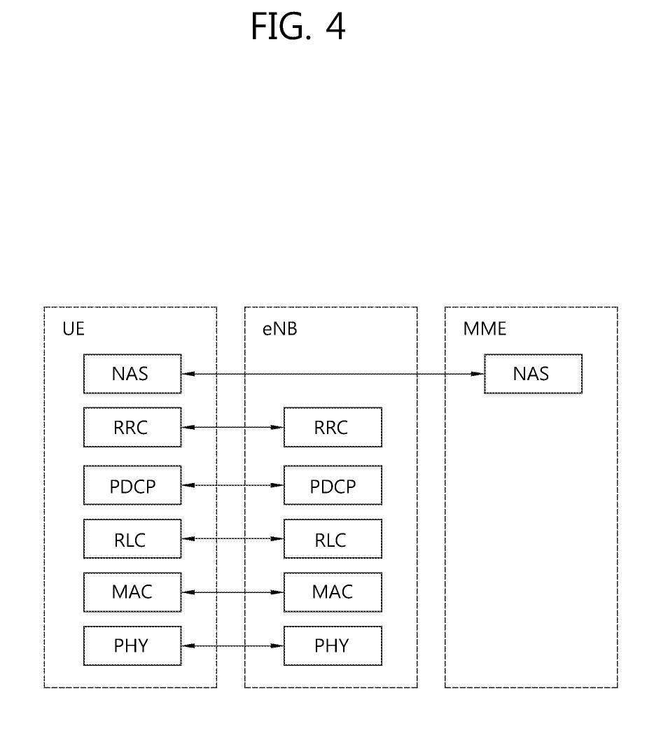

FIG. 3 shows a block diagram of a user plane protocol stack of an LTE system. FIG. 4 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or Ipv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3, the RLC and MAC layers (terminated in the eNB on the network side) may perform functions such as scheduling, automatic repeat request (ARQ), and hybrid ARQ (HARQ). The PDCP layer (terminated in the eNB on the network side) may perform the user plane functions such as header compression, integrity protection, and ciphering.

Referring to FIG. 4, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

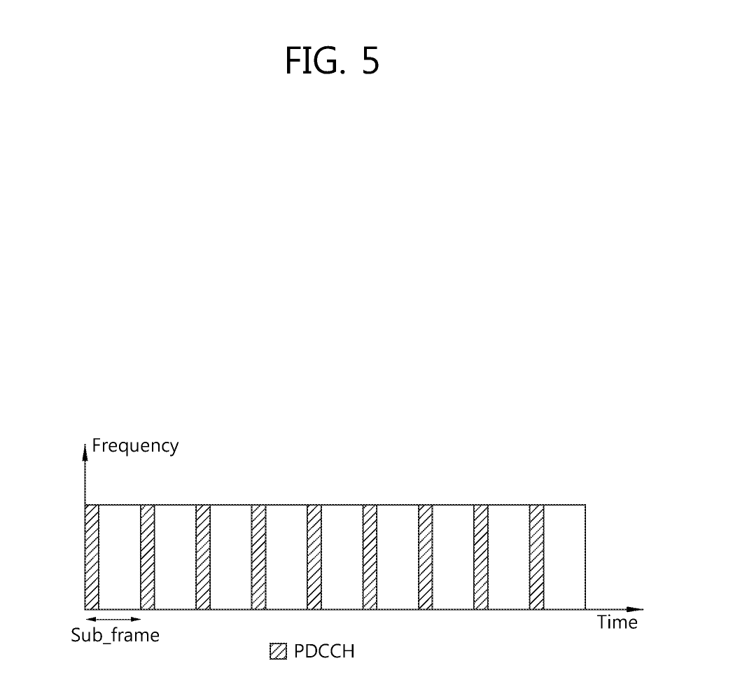

FIG. 5 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is 1 ms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, a uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

MBMS is described. It may be referred to Section 15 of 3GPP TS 36.300 V11.7.0 (2013-09), and Section 5.8 of 3GPP TS 36.331 V11.5.0 (2013-09).

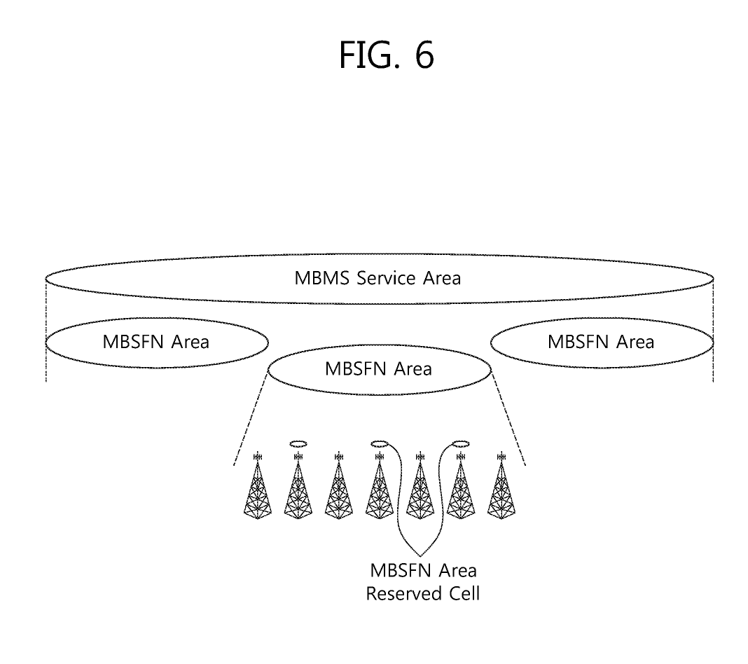

FIG. 6 shows MBMS definitions. For MBMS, the following definitions may be introduced.
Multicast-broadcast single-frequency network (MBSFN) synchronization area: This is an area of the network where all eNBs can be synchronized and perform MBSFN transmissions. MBSFN synchronization areas are capable of supporting one or more MBSFN areas. On a given frequency layer, an eNB can only belong to one MBSFN synchronization area. MBSFN synchronization areas are independent from the definition of MBMS service areas.
MBSFN transmission or a transmission in MBSFN mode: This is a simulcast transmission technique realized by transmission of identical waveforms at the same time from multiple cells. An MBSFN transmission from multiple cells within the MBSFN area is seen as a single transmission by a UE.
MBSFN area: an MBSFN area consists of a group of cells within an MBSFN synchronization area of a network, which are coordinated to achieve an MBSFN transmission. Except for the MBSFN area reserved cells, all cells within an MBSFN area contribute to the MBSFN transmission and advertise its availability. The UE may only need to consider a subset of the MBSFN areas that are configured, i.e., when it knows which MBSFN area applies for the service(s) it is interested to receive.
MBSFN area reserved cell: This is a cell within a MBSFN area which does not contribute to the MBSFN transmission. The cell may be allowed to transmit for other services but at restricted power on the resource allocated for the MBSFN transmission.
Synchronization sequence: Each synchronization protocol data unit (SYNC PDU) contains a time stamp which indicates the start time of the synchronization sequence. For an MBMS service, each synchronization sequence has the same duration which is configured in the broadcast and multicast service center (BM-SC) and the multi-cell/multicast coordination entity (MCE).
Synchronization period: The synchronization period provides the time reference for the indication of the start time of each synchronization sequence. The time stamp which is provided in each SYNC PDU is a relative value which refers to the start time of the synchronization period. The duration of the synchronization period is configurable.

In general, the control information relevant only for UEs supporting MBMS is separated as much as possible from unicast control information. Most of the MBMS control information is provided on a logical channel specific for MBMS common control information, i.e. the MCCH. E-UTRA employs one MCCH logical channel per MBSFN area. In case the network configures multiple MBSFN areas, the UE acquires the MBMS control information from the MCCHs that are configured to identify if services it is interested to receive are ongoing. An MBMS capable UE may be only required to support reception of a single MBMS service at a time. The MCCH carries the MBSFNAreaConfiguration message, which indicates the MBMS sessions that are ongoing as well as the (corresponding) radio resource configuration. The MCCH may also carry the MBMSCountingRequest message, when E-UTRAN wishes to count the number of UEs in RRC_CONNECTED that are receiving or interested to receive one or more specific MBMS services.

A limited amount of MBMS control information is provided on the BCCH. This primarily concerns the information needed to acquire the MCCH(s). This information is carried by means of a single MBMS specific SystemInformationBlock, i.e. SystemInformationBlockType13. An MBSFN area is identified solely by the mbsfn-AreaId in SystemInformationBlockType13. At mobility, the UE considers that the MBSFN area is continuous when the source cell and the target cell broadcast the same value in the mbsfn-AreaId.

The MCCH information is transmitted periodically, using a configurable repetition period. Scheduling information is not provided for MCCH, i.e. both the time domain scheduling as well as the lower layer configuration are semi-statically configured, as defined within SystemInformationBlockType13.

For MBMS user data, which is carried by the MTCH logical channel, E-UTRAN periodically provides MCH scheduling information (MSI) at lower layers (MAC). This MCH information only concerns the time domain scheduling, i.e. the frequency domain scheduling and the lower layer configuration are semi-statically configured. The periodicity of the MSI is configurable and defined by the MCH scheduling period.

Change of MCCH information only occurs at specific radio frames, i.e. the concept of a modification period is used. Within a modification period, the same MCCH information may be transmitted a number of times, as defined by its scheduling (which is based on a repetition period). The modification period boundaries are defined by system frame number (SFN) values for which SFN mod m=0, where m is the number of radio frames comprising the modification period. The modification period is configured by means of SystemInformationBlockType13.

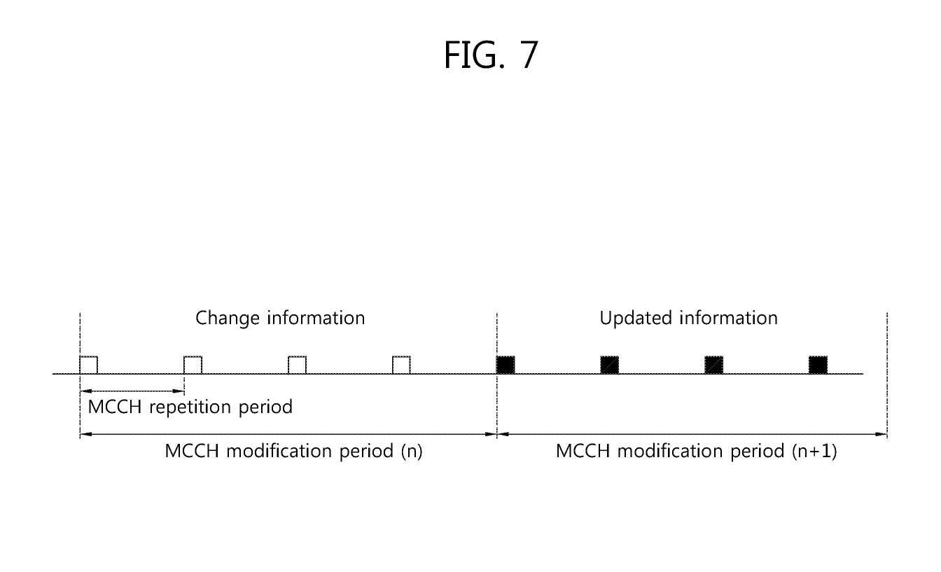

FIG. 7 shows change of MCCH information. When the network changes (some of) the MCCH information, it notifies the UEs about the change during a first modification period. In the next modification period, the network transmits the updated MCCH information. In FIG. 7, different colors indicate different MCCH information. Upon receiving a change notification, a UE interested to receive MBMS services acquires the new MCCH information immediately from the start of the next modification period. The UE applies the previously acquired MCCH information until the UE acquires the new MCCH information.

Indication of an MBMS specific RNTI, the M-RNTI, on PDCCH is used to inform UEs in RRC_IDLE and UEs in RRC_CONNECTED about an MCCH information change. When receiving an MCCH information change notification, the UE knows that the MCCH information will change at the next modification period boundary. The notification on PDCCH indicates which of the MCCHs will change, which is done by means of an 8-bit bitmap. Within this bitmap, the bit at the position indicated by the field notificationIndicator is used to indicate changes for that MBSFN area: if the bit is set to “1”, the corresponding MCCH will change. No further details are provided, e.g. regarding which MCCH information will change. The MCCH information change notification is used to inform the UE about a change of MCCH information upon session start or about the start of MBMS counting.

The MCCH information change notifications on PDCCH are transmitted periodically and are carried on MBSFN subframes only. These MCCH information change notification occasions are common for all MCCHs that are configured, and configurable by parameters included in SystemInformationBlockType13: a repetition coefficient, a radio frame offset and a subframe index. These common notification occasions are based on the MCCH with the shortest modification period.

The E-UTRAN may modify the MBMS configuration information provided on MCCH at the same time as updating the MBMS configuration information carried on BCCH, i.e. at a coinciding BCCH and MCCH modification period. Upon detecting that a new MCCH is configured on BCCH, a UE interested to receive one or more MBMS services should acquire the MCCH, unless it knows that the services it is interested in are not provided by the corresponding MBSFN area.

A UE that is receiving an MBMS service shall acquire the MCCH information from the start of each modification period. A UE that is not receiving an MBMS service, as well as UEs that are receiving an MBMS service but potentially interested to receive other services not started yet in another MBSFN area, shall verify that the stored MCCH information remains valid by attempting to find the MCCH information change notification at least notificationRepetitionCoeff times during the modification period of the applicable MCCH(s), if no MCCH information change notification is received.

In case the UE is aware which MCCH(s) E-UTRAN uses for the service(s) it is interested to receive, the UE may only need to monitor change notifications for a subset of the MCCHs that are configured, referred to as the ‘applicable MCCH(s)’ in the above.

MCCH information acquisition procedure is described. The UE applies the MCCH information acquisition procedure to acquire the MBMS control information that is broadcasted by the E-UTRAN. The procedure applies to MBMS capable UEs that are in RRC_IDLE or in RRC_CONNECTED. A UE interested to receive MBMS services shall apply the MCCH information acquisition procedure upon entering the corresponding MBSFN area (e.g. upon power on, following UE mobility) and upon receiving a notification that the MCCH information has changed. A UE that is receiving an MBMS service shall apply the MCCH information acquisition procedure to acquire the MCCH, which corresponds with the service that is being received, at the start of each modification period.

Unless explicitly stated otherwise in the procedural specification, the MCCH information acquisition procedure overwrites any stored MCCH information, i.e. delta configuration is not applicable for MCCH information and the UE discontinues using a field if it is absent in MCCH information unless explicitly specified otherwise.

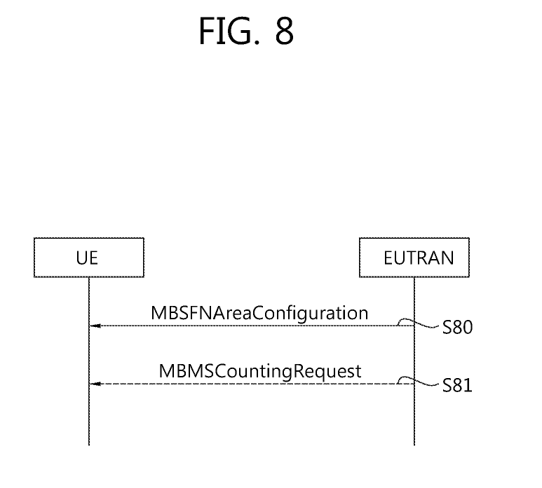

FIG. 8 shows an MCCH information acquisition procedure. An MBMS capable UE shall:

1> if the procedure is triggered by an MCCH information change notification:
2> start acquiring the MBSFNAreaConfiguration message (in step S80) and the MBMSCountingRequest message if present (in step S81), from the beginning of the modification period following the one in which the change notification was received;
1> if the UE enters an MBSFN area:
2> acquire the MBSFNAreaConfiguration message (in step S80) and the MBMSCountingRequest message if present (in step S81), at the next repetition period;
1> if the UE is receiving an MBMS service:
2> start acquiring the MBSFNAreaConfiguration message (in step S80) and the MBMSCountingRequest message if present (in step S81), that both concern the MBSFN area of the service that is being received, from the beginning of each modification period;

MBMS interest indication is described. The purpose of this procedure is to inform E-UTRAN that the UE is receiving or is interested to receive MBMS via an MBMS radio bearer (MRB), and if so, to inform the E-UTRAN about the priority of MBMS versus unicast reception. An MBMS capable UE in RRC_CONNECTED may initiate the procedure in several cases including upon successful connection establishment, upon entering or leaving the service area, upon session start or stop, upon change of interest, upon change of priority between MBMS reception and unicast reception or upon change to a primary cell (PCell) broadcasting SystemInformationBlockType15.

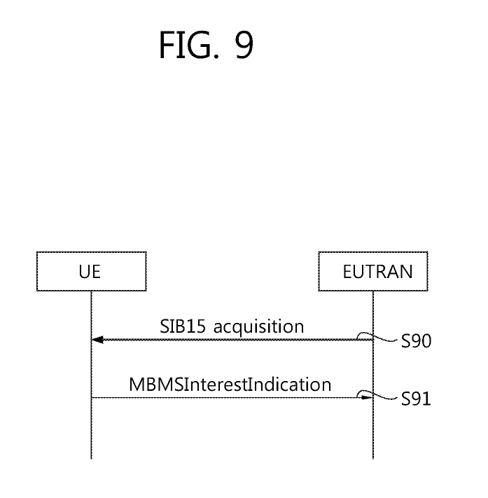

FIG. 9 shows an MBMS interest indication procedure. Upon initiating the procedure, the UE shall:

1> if SystemInformationBlockType15 is broadcast by the PCell (in step S90):
2> ensure having a valid version of SystemInformationBlockType15 for the PCell;
2> if the UE did not transmit an MBMSInterestIndication message since last entering RRC_CONNECTED; or
2> if since the last time the UE transmitted an MBMSInterestIndication message, the UE connected to a PCell not broadcasting SystemInformationBlockType15:
3> if the set of MBMS frequencies of interest is not empty:
4> initiate transmission of the MBMSInterestIndication message (in step S91);
2> else:
3> if the set of MBMS frequencies of interest has changed since the last transmission of the MBMSInterestIndication message; or
3> if the prioritization of reception of all indicated MBMS frequencies compared to reception of any of the established unicast bearers has changed since the last transmission of the MBMSInterestIndication message:
4> initiate transmission of the MBMSInterestIndication message (in step S91).

The UE may send an MBMSInterestIndication even when it is able to receive the MBMS services it is interested in i.e. to avoid that the network allocates a configuration inhibiting MBMS reception.

To determine MBMS frequencies of interest, the UE shall:

1> consider a frequency to be part of the MBMS frequencies of interest if the following conditions are met:
2> at least one MBMS session the UE is receiving or interested to receive via an MRB is ongoing or about to start; and
2> for at least one of these MBMS sessions SystemInformationBlockType15 acquired from the PCell includes for the concerned frequency one or more MBMS service area identifiers (SAIs) as indicated in the user service description (USD) for this session; and
2> the UE is capable of simultaneously receiving the set of MBMS frequencies of interest, regardless of whether a serving cell is configured on each of these frequencies or not; and
2> the supportedBandCombination the UE included in UE-EUTRA-Capability contains at least one band combination including the set of MBMS frequencies of interest.

Indicating a frequency implies that the UE supports SystemInformationBlockType13 acquisition for the concerned frequency, i.e., the indication should be independent of whether a serving cell is configured on that frequency. When evaluating which frequencies it can receive simultaneously, the UE does not take into account the serving frequencies that are currently configured, i.e., it only considers MBMS frequencies it is interested to receive. The term frequency does not indicate a physical frequency but covers the associated band(s), noting that additional bands may be indicated in SystemInformationBlockType1 (serving frequency) or SystemInformationBlockType15 (neighboring frequencies).

The UE shall set the contents of the MBMSInterestIndication message as follows:

1> if the set of MBMS frequencies of interest is not empty:
2> include mbms-FreqList and set it to include the MBMS frequencies of interest, using the E-UTRA absolute radio frequency channel number (EARFCN) corresponding with freqBandIndicator included in SystemInformationBlockType1 (for serving frequency), if applicable, and the EARFCN(s) as included in SystemInformationBlockType15 (for neighboring frequencies);
2> include mbms-Priority if the UE prioritizes reception of all indicated MBMS frequencies above reception of any of the unicast bearers.

The UE shall submit the MBMSInterestIndication message to lower layers for transmission.

MBMS counting procedure is described. The MBMS counting procedure is used by the E-UTRAN to count the number of RRC_CONNECTED mode UEs which are receiving via an MRB or interested to receive via an MRB the specified MBMS services. The UE determines interest in an MBMS service, which is identified by the temporary mobile group identifier (TMGI), by interaction with upper layers.

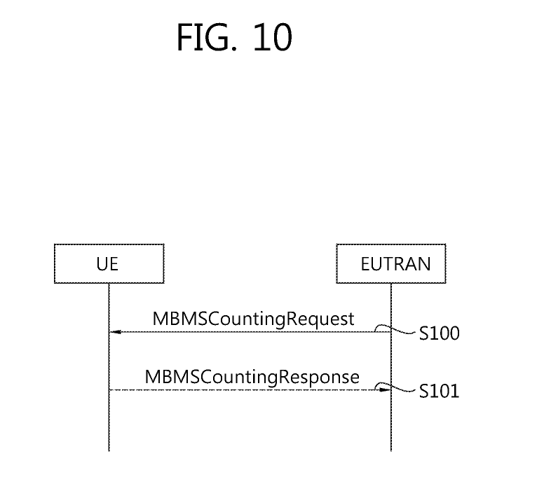

FIG. 10 shows an MBMS counting procedure. In step S100, the E-UTRAN initiates the procedure by sending an MBMSCountingRequest message to the UE. Upon receiving the MBMSCountingRequest message, the UE in RRC_CONNECTED shall:

1> if the SystemInformationBlockType1 that provided the scheduling information for the systemInformationBlockType13 that included the configuration of the MCCH via which the MBMSCountingRequest message was received, contained the identity of the registered PLMN; and
1> if the UE is receiving via an MRB or interested to receive via an MRB at least one of the services in the received countingRequestList:
2> if more than one entry is included in the mbsfn-AreaInfoList received in the SystemInformationBlockType13 that included the configuration of the MCCH via which the MBMSCountingRequest message was received:
3> include the mbsfn-AreaIndex in the MBMSCountingResponse message and set it to the index of the entry in the mbsfn-AreaInfoList within the received SystemInformationBlockType13 that corresponds with the MBSFN area used to transfer the received MBMSCountingRequest message;
2> for each MBMS service included in the received countingRequestList:
3> if the UE is receiving via an MRB or interested to receive via an MRB this MBMS service:
4> include an entry in the countingResponseList within the MBMSCountingResponse message with countingResponseService set it to the index of the entry in the countingRequestList within the received MBMSCountingRequest that corresponds with the MBMS service the UE is receiving or interested to receive;
2> submit the MBMSCountingResponse message to lower layers for transmission upon which the procedure ends, in step S101;

UEs that are receiving an MBMS user service by means of a unicast bearer service (i.e., via a DRB), but are interested to receive the concerned MBMS user service via an MBMS bearer service (i.e., via an MRB), respond to the counting request. If ciphering is used at upper layers, the UE does not respond to the counting request if it cannot decipher the MBMS service for which counting is performed. The UE treats the MBMSCountingRequest messages received in each modification period independently. In the unlikely case the E-UTRAN would repeat an MBMSCountingRequest (i.e., including the same services) in a subsequent modification period, the UE responds again.

System Information related to MBMS, i.e. SystemInformationBlockType13 (i.e. SIB13) and SystemInformationBlockType15 (i.e. SIB15) is described. The IE SystemInformationBlockType13 contains the information required to acquire the MBMS control information associated with one or more MBSFN areas. Table 1 shows the SystemInformationBlockType13 IE.

TABLE 1

| -- ASN1START | |
|---|---|
| SystemInformationBlockType13-r9 ::= SEQUENCE { | |
| mbsfh-AreaInfoList-r9 | MBSFN-AreaInfoList-r9, |

| | |
|---|---|
| notificationConfig-r9 | MBMS-NotificationConfig-r9, |
| lateNonCriticalExtension | OCTET STRING |
| OPTIONAL, | |
| ... | |
| } | |
| -- ASN1STOP | |

Referring to Table 1, the SystemInformationBlockType13 IE includes the IE MBSFN-AreaInfoList IE, which contains the information required to acquire the MBMS control information associated with one or more MBSFN areas. The SystemInformationBlockType13 IE further includes the MBMS-NotificationConfig IE, which specifies the MBMS notification related configuration parameters that are applicable for all MBSFN areas.

The IE SystemInformationBlockType15 contains the MBMS SAI of the current and/or neighboring carrier frequencies. Table 2 shows the SystemInformationBlockType15 IE.

TABLE 2
-- ASN1START
SystemInformationBlockType15-r11 ::= SEQUENCE {

| | | |
|---|---|---|
| mbms-SAI-IntraFreq-r11 | MBMS-SAI-List-r11 | OPTIONAL, - |

- Need OR

| | | |
|---|---|---|
| mbms-SAI-InterFreqList-r11 | MBMS-SAI-InterFreqList-r11 | OPTIONAL, -- |

Need OR

| | | |
|---|---|---|
| lateNonCriticalExtension | OCTET STRING | OPTIONAL, |

...,

| | | |
|---|---|---|
| [[ mbms-SAI-InterFreqList-v1140 | MBMS-SAI-InterFreqList-v1140 | OPTIONAL -- |

Cond InterFreq
]]
}
MBMS-SAI-List-r11 ::= SEQUENCE (SIZE (1..maxSAI-MBMS-r11)) OF MBMS-SAI-r11
MBMS-SAI-r11 ::= INTEGER (0..65535)
MBMS-SAI-InterFreqList-r11 ::= SEQUENCE (SIZE (1..maxFreq)) OF MBMS-SAI-
InterFreq-r11
MBMS-SAI-InterFreqList-v1140 ::= SEQUENCE (SIZE (1..maxFreq)) OF MBMS-SAI-
InterFreq-v1140

| | |
|---|---|
| MBMS-SAI-InterFreq-r11 ::= | SEQUENCE { |
| dl-CarrierFreq-r11 | ARFCN-ValueEUTRA-r9, |

| | |
|---|---|
| mbms-SAI-List-r11 | MBMS-SAI-List-r11 |

}

| | |
|---|---|
| MBMS-SAI-InterFreq-v1140 ::= | SEQUENCE { |

| | | | |
|---|---|---|---|
| multiBandInfoList-r11 | MultiBandInfoList-r11 | OPTIONAL | -- |

Need OR
}
-- ASN1STOP

Referring to Table 2, the SystemInformationBlockType15 IE includes the mbms-SAI-InterFreqList field, which contains a list of neighboring frequencies including additional bands, if any, that provide MBMS services and the corresponding MBMS SAIs. The SystemInformationBlockType15 IE further includes the mbms-SAI-IntraFreq IE, which contains the list of MBMS SAIs for the current frequency. The mbms-SAI-List IE contains a list of MBMS SAIs for a specific frequency.

Hereinafter, a method for supporting TV broadcast by LTE MBMS according to an embodiment of the present invention is described. According to an embodiment of the present invention, the UE may read a system information block, such as SIB13, to acquire MBSFN area configuration including configuration of MBMS channels, such as PMCH configuration. If the UE reads the SIB13 on the LTE frequency or TV broadcast frequency, the UE may know configuration of MBMS channels, and accordingly, the UE may be able to receive MBMS services on either the LTE frequency or TV broadcast frequency. Further, the UE may read another system information block, such as SIB15, to acquire information on service areas near UE's location such as SAI per neighboring frequency. The frequency may be either the LTE frequency or TV broadcast frequency. Further, the UE may acquire start/stop time of a specific MBMS service, and/or mapping between service area (or MBSFN area or frequency) and a specific MBMS service, via TV program/guide, USD, system information such as SIB13, SIB15 or a new SIB, or a dedicated signaling, from the network. Accordingly, the UE may know when an interested MBMS service will start or stop and which service area/MBSFN area/frequency provides an interested MBMS service.

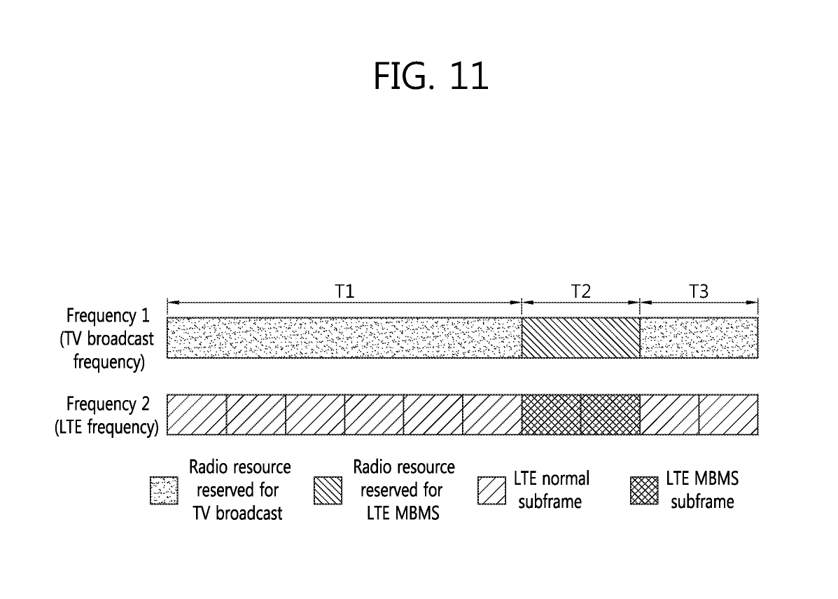

FIG. 11 shows an example of TV broadcast by LTE MBMS according to an embodiment of the present invention. Referring to FIG. 11, frequency 1 is a TV broadcast frequency, and frequency 2 is a LTE frequency. During T1 and T3, TV services are broadcast on frequency 1 via TV broadcast system and communication services are provided on frequency 2 via LTE system. The TV broadcast system may be one of TV standard technologies, such as digital video broadcasting (DVB), advanced television systems committee (ATSC), or future of broadcast television (FOBTV). On the other hand, during T2, TV services are broadcast on frequency 1 via LTE MBMS. T2 is a time period reserved for LTE MBMS. One or multiple MBSFN areas, up to 8, may be configured on the TV broadcast frequency.

Various UE behaviors to receive TV broadcast services on the TV broadcast frequency via LTE MBMS according to an embodiment of the present invention are described.

First, reception of the MBMS related system information by the UE according to an embodiment of the present invention is described. Depending on which frequency the MBMS related system information, i.e. SIB13 and/or SIB15, is received, the following options may be considered.

(1) The UE may receive the whole MBMS related system information from a cell on the LTE frequency. In this case, there is no LTE system information on TV broadcast frequency, and therefore, the UE may not try to acquire the MBMS related system information on the TV broadcast frequency.

The UE may read SIB1 from a cell on the LTE frequency to acquire scheduling of other system information. Then, the UE may read SIB13 or SIB15 from a cell on the LTE frequency. Alternatively, the new SIB may be defined for TV broadcast via LTE MBMS.

The SIB13/SIB15/new SIB may include following information about MBSFN area configured on the TV broadcast frequency:
MBSFN area identity
Information on TV broadcast system, which may include at least one of system type (e.g. ATSC), system version (e.g. ATSC 2.0), downlink bandwidth for TV broadcast, or TV broadcast frequency and time frames where the MBSFN area is configured.
non-MBSFNregionLength
notificationIndicator
MCCH allocation information, which may include at least one of MCCH repetition period, MCCH offset, MCCH modification period, Subframe allocation information, MCS level of MCCH
Guide information on TV programs that are provided in the MBSFN area

(2) The UE may receive part of MBMS related system information from a cell on the LTE frequency. In this case, there is only SIB13 and/or SIB15 on the TV broadcast frequency and UE may not try to acquire other SIB on the TV broadcast frequency.

The UE may read SIB1 from a cell on the LTE frequency to acquire scheduling of other system information. The SIB1 may also include scheduling information of SIB13 on the TV broadcast frequency. The SIB1 may also include information on the TV broadcast system, which may include at least one of system type (e.g. ATSC), system version (e.g. ATSC 2.0), downlink bandwidth for TV broadcast, or the TV broadcast frequency and time frames where the MBSFN area is configured.

Then, the UE may read SIB15 from the cell on the LTE frequency. The SIB15 includes the following information about MBMS service area configured on the TV broadcast frequency.
TV broadcast frequency and time frames where the MBMS service area is configured
MBMS SAI: The UE may be able to know which MBMS service area provides the interested TV service by receiving USD via application layer.
System type (e.g. ATSC), and system version (e.g. ATSC 2.0)
Downlink bandwidth for TV broadcast
Guide information on TV programs that are provided in the MBMS service area

Then, the UE may read SIB13 from a node on the TV broadcast frequency. On the TV broadcast frequency, the SIB13 may be transmitted during time period which is reserved for LTE MBMS. If the UE is in RRC_IDLE, the UE may keep camping on the LTE cell to receive paging message. If the UE is in RRC_CONNECTED, the UE may keep RRC connection with the LTE cell.

(3) The UE may receive the whole MBMS related system information from a node on the TV broadcast frequency. The UE may read SIB1 from a cell on the LTE frequency to acquire scheduling of other system information including SIB1/SIB13/SIB15 on the TV broadcast frequency.

Then, the UE may read SIB15 from the cell on the LTE frequency. The SIB15 includes the following information about MBMS service area configured on the TV broadcast frequency.
TV broadcast frequency and time frames where the MBMS service area is configured
MBMS SAI
System type (e.g. ATSC), and system version (e.g. ATSC 2.0)
Downlink bandwidth for TV broadcast
Guide information on TV programs that are provided in the MBMS service area

Then, the UE may reads SIB1 from a node on the TV broadcast frequency to acquire scheduling of the SIB13 including a value tag, which indicate whether or not SIB13/SIB15 on the TV broadcast frequency is updated. The UE may read SIB13 from a node on the TV broadcast frequency, and may read SIB15 from a node on the intra/inter TV broadcast frequency.

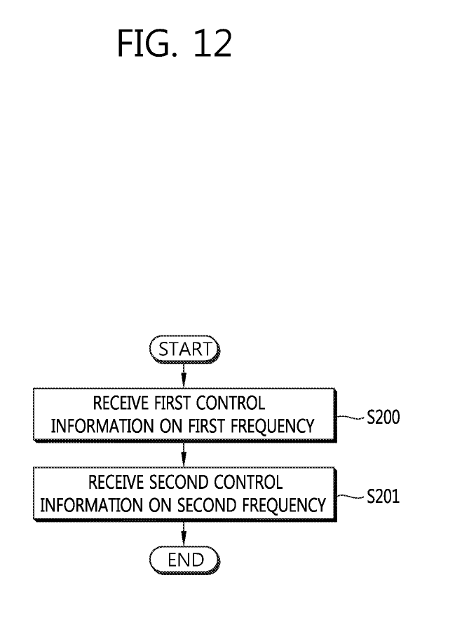

FIG. 12 shows an example of a method for receiving information for TV broadcast according to an embodiment of the present invention. In step S200, the UE receives first control information on a first frequency. In step S201, the UE receives second control information on a second frequency. The first frequency may be a 3GPP LTE frequency, and the second frequency may be a TV broadcast frequency.

The first control information may include scheduling information for the second control information. The first control information may include a SIB1. The first control information may include information on TV broadcast system. The information on TV broadcast system may include at least one of a system type of the TV broadcast system, a system version of the TV broadcast system, downlink bandwidth for the TV broadcast system, or the second frequency and time frames where a multicast-broadcast single-frequency network (MBSFN) area is configured.

The first control information may include scheduling information for user data on the second frequency. The first control information may include a SIB15. The first control information may include information on MBMS service area configured on the second frequency. The information on MBMS service area configured on the second frequency may include the second frequency and time frames where the MBMS service area is configured.

The second control information may include scheduling information for user data on the second frequency. The second control information may include a SIB13 or SIB15. The second control information may be received during a time period which is reserved for LTE MBMS.

Reception of the MBSFN area configuration according to an embodiment of the present invention is described. According to an embodiment of the present invention, the MBSFN area configuration message may be transmitted on either the LTE frequency or TV broadcast frequency. The MBSFN area configuration message may include at least one of MTCH allocation information or MBMS session information. The MTCH allocation information may include at least one of TV broadcast frequency where the MTCH is configured, radio-frames that are reserved for LTE MBMS on the TV broadcast frequency, subframes that are reserved for LTE MBMS on the TV broadcast frequency or time period reserved for LTE MBMS on the TV broadcast frequency. The MBMS session information may include at least one of service identities or service group identities on the TV broadcast frequency, logical channel identity (LCID) on the TV broadcast frequency or MCS level of MTCH on the TV broadcast frequency.

The UE may receive the MBSFN area configuration message on MCCH from a cell on the LTE frequency. In this case, only MTCH may be configured on the TV broadcast frequency and a corresponding MCCH may be configured on the LTE frequency. One MCCH transmitted on the LTE frequency may be configured either for each TV broadcast frequency or for all TV broadcast frequencies. One or more MCCH configured for TV broadcast frequencies may be transmitted either at non-MBSFN subframes or at MBSFN subframes on the LTE frequency. If the MCCH is transmitted on the MBSFN subframes, all MCCH configured for TV broadcast frequencies may be transmitted on a single MBSFN area of the LTE frequency. Or, different MCCH configured for TV broadcast frequencies may be transmitted on different MBSFN areas of the LTE frequency. Alternatively, the UE may receive the MBSFN area configuration message from a node on the TV broadcast frequency. Alternatively, the UE may receive the MBSFN area configuration message on DCCH from a cell on the LTE frequency. Alternatively, the UE may receive the MBSFN area configuration message via system information on BCCH from a cell on the LTE frequency.

Reception of the MCCH change notification according to an embodiment of the present invention is described. The UE may receive the MCCH change notification from a cell on the LTE frequency. The MCCH change notification indicates update of MBSFN area configuration information on the TV broadcast frequency. If the MCCH change notification indicates the update, the PDCCH may indicate either M-RNTI or a new RNTI to notify the UE about the MCCH change notification. The PDCCH may also include a bit (for each TV broadcast frequency, for each MBSFN area on the TV broadcast frequency, or for all TV broadcast frequencies) to notify the UE about the MCCH change notification. The UE may keep monitoring the PDCCH on the LTE frequency, while receiving TV broadcast service on the TV broadcast frequency to receive the MCCH change notification. If UE receives the MCCH change notification, the UE may receive the updated MBSFN area configuration information in the next modification period.

Alternatively, the UE may receive the MCCH change notification from a node on the TV broadcast frequency. In this case, the UE may monitor PDCCH, paging message, or a new notification message on the TV broadcast frequency to receive the MCCH change notification.

TV broadcast interest indication procedure according to an embodiment of the present invention is described. Like the MBMS interest indication procedure described in FIG. 9, the TV broadcast interest indication procedure may be newly defined in order to inform E-UTRAN that the UE is receiving or is interested to receive TV broadcast service via LTE MBMS. An TV broadcast capable UE in RRC_CONNECTED may initiate the TV broadcast interest indication procedure upon successful connection establishment, upon entering or leaving the TV broadcast service area, upon start or stop of interested TV broadcast service, upon change of TV broadcast interest, upon change of priority between TV broadcast reception and LTE reception, or upon change to a PCell broadcasting assistance information for TV broadcast.

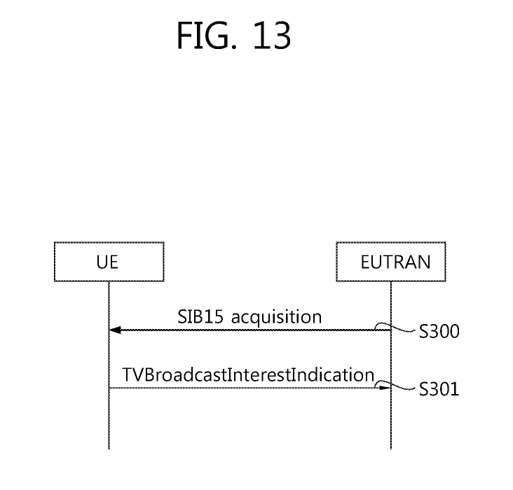

FIG. 13 shows an example of a TV broadcast interest indication procedure according to an embodiment of the present invention. In step S300, the UE acquires the SIB15 from E-UTRAN. In step S301, the UE informs E-UTRAN of TV broadcast frequencies of interest via TVBroadcastInterestIndication message. Alternatively, if there is only one frequency where the TV broadcast service is provided, the UE may inform E-UTRAN that it is receiving or is interested to receive TV broadcast service via LTE MBMS, by using 1 bit indicator without notifying frequency information. Alternatively, the TV broadcast interest indication may be included in the existing MBMSInterestIndication message. The UE may determine whether the session is ongoing from the start and stop time indicated in the USD. The TV broadcast interest indication may include a priority of MBMS reception on the TV broadcast frequency over either a priority of unicast service on the LTE frequency or a priority of MBMS reception on the LTE frequency.

TV broadcast counting procedure according to an embodiment of the present invention is described. Like the MBMS counting procedure described in FIG. 10, the TV broadcast counting procedure may be newly defined in order to count the number of RRC_CONNECTED mode UEs which are receiving or interested to receive the specified TV broadcast services. To survey ratings, the TV broadcast counting procedure may be performed on the LTE frequency.

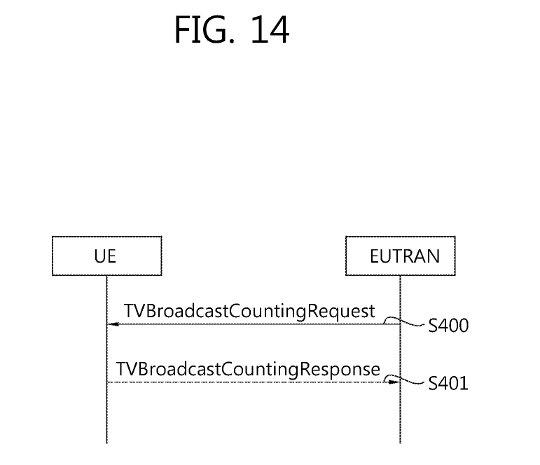

FIG. 14 shows an example of a TV broadcast counting procedure according to an embodiment of the present invention. In step S400, the E-UTRAN initiates the procedure by sending a TVBroadcastCountingRequest message to the UE. The TVBroadcastCountingRequest message may include a TV broadcast service identity list. Further, the TVBroadcastCountingRequest message may indicate a list of TV broadcast frequencies, a list of MBSFN areas of a TV broadcast frequency, or a list of TV services. The TVBroadcastCountingRequest message may be included in the existing MBMSCountingRequest message.

If the UE is receiving or interested to receive at least one TV broadcast service among the received TV broadcast service identity list in the TVBroadcastCountingRequest message via TV broadcast, in step S401, the UE inform the serving cell of interested TV broadcast services among the listed TV broadcast services via TVBroadcastCountingResponse message. Or, if the UE is receiving or interested to receive TV service on the TV broadcast frequency or on a MBSFN area of the TV broadcast frequency in the TVBroadcastCountingRequest message, in step S401, the UE inform the serving cell about the TV broadcast frequency or the MBSFN area via TVBroadcastCountingResponse message. The TVBroadcastCountingResponse message may be included in the existing MBMSCountingResponse message.

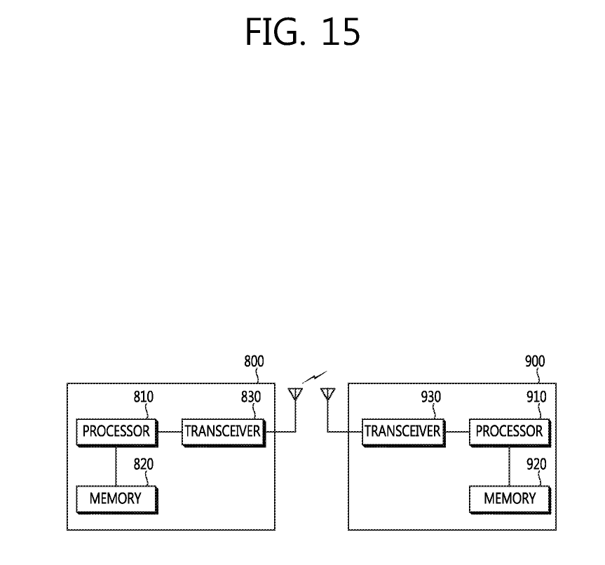

FIG. 15 shows a wireless communication system to implement an embodiment of the present invention.

An eNB 800 may include a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A UE 900 may include a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for receiving, by a user equipment (UE), information for TV broadcast in a wireless communication system, the method comprising:
receiving first control information on a first frequency; and
receiving second control information on a second frequency.

2. The method of claim 1, wherein the first frequency is a 3rd generation partnership project (3GPP) long-term evolution (LTE) frequency.

3. The method of claim 1, wherein the second frequency is a TV broadcast frequency.

4. The method of claim 1, wherein the first control information includes scheduling information for the second control information.

5. The method of claim 4, wherein the first control information includes a system information block type 1 (SIB1).

6. The method of claim 5, wherein the first control information includes information on TV broadcast system.

7. The method of claim 6, wherein the information on TV broadcast system includes at least one of a system type of the TV broadcast system, a system version of the TV broadcast system, downlink bandwidth for the TV broadcast system, or the second frequency and time frames where a multicast-broadcast single-frequency network (MBSFN) area is configured.

8. The method of claim 1, wherein the first control information includes scheduling information for user data on the second frequency.

9. The method of claim 8, wherein the first control information includes a SIB15.

10. The method of claim 9, wherein the first control information includes information on multimedia broadcast multicast service (MBMS) service area configured on the second frequency.

11. The method of claim 10, wherein the information on MBMS service area configured on the second frequency includes the second frequency and time frames where the MBMS service area is configured.

12. The method of claim 1, wherein the second control information includes scheduling information for user data on the second frequency.

13. The method of claim 12, wherein the second control information includes a SIB13 or SIB15.

14. The method of claim 12, wherein the second control information is received during a time period which is reserved for LTE MBMS.

15. A user equipment (UE) comprising:
a memory;
a transceiver; and
a processor coupled to the memory and the transceiver, and configured to:
control the transceiver to receive first control information on a first frequency; and
control the transceiver to receive second control information on a second frequency.
